(19) United States
(12) Patent Application Publication
(10) Pub. No.: US 2007/0203819 A1
(43) Pub. Date: Aug. 30, 2007

(54) SYSTEM, METHOD, APPARATUS AND PRODUCT FOR USE IN ASSOCIATION WITH TRANSACTIONS

(76) Inventor: Paul Efron, Larchmont, NY (US)

Correspondence Address: BUCKLEY, MASCHOFF & TALWALKAR LLC, 50 LOCUST AVENUE, NEW CANAAN, CT, 06840, US

(21) Appl. No.: 11/672,410

(22) Filed: Feb. 7, 2007

Related U.S. Application Data
(60) Provisional application No. 60/765,827, filed on Feb. 7, 2006.

(51) Int. Cl. G06Q 40/00

(52) U.S. Cl. 705/36 T

(57) ABSTRACT

Systems, methods, apparatus and/or computer program products presented herein may be used in association with transactions. In one aspect, a method includes issuing a number of shares of a first entity to a second entity, where the second entity is a bankruptcy remote subsidiary of the first entity, creating a forward sale contract in which the second entity sells the number of shares of the first entity to a third entity, creating an agreement between at least one of the first entity and the second entity in which that entity borrows funds from a fourth entity, and creating at least one of a pledge and a security interest in which the fourth entity's right to repayment is secured by the right of the second entity to be paid under the forward sale contract.

### CROSS REFERENCE TO RELATED APPLICATIONS

This application claims priority to, and hereby incorporates by reference for all purposes, U.S. Provisional patent application Ser. No. 60/765,827, entitled “FORWARD EQUITY SALE” filed in the name of Paul Efron on Feb. 7, 2006.

### TECHNICAL FIELD

The present invention relates to systems, methods, apparatus and computer program products for use in association with transactions.

### BACKGROUND

Investment grade companies with a relatively strong credit standing frequently enter into forward contracts to sell their common stock in a form of financing known as a “mandatory convertible”. A mandatory convertible is a type of bond that must be converted and/or redeemed for an equity security, i.e., one or more shares of stock, at some time in the future.

In general, the rationale for such a transaction may include: (1) the Company obtains deductibility for tax purposes on its outstanding indebtedness until the stock is issued at the maturity of the contract and the proceeds are used to retire debt, (2) the accounting for a forward contract is in many cases more favorable than for outright issuance as the Company is required to use the Treasury Stock Method which frequently results in less initial dilution of the Company's earnings per share, and (3) the Company can participate in the future appreciation of its common stock by embedding into the forward contract a call option that allows it to deliver fewer shares if its stock price appreciates.

Unfortunately, mandatory convertibles, and their associated benefits, are generally unavailable to non-investment grade companies because the forward contract automatically terminates in bankruptcy. This is because (1) under law, a bankrupt Company is not permitted to issue shares and (2) for tax reasons, if the forward sale is sold as a package with an accompanying issuance of debt, failure of the contract to terminate in bankruptcy could jeopardize the ability of the Company to receive tax deductions on the accompanying debt.

Companies of lower credit quality have a much higher probability of becoming insolvent in the near term than those of higher credit quality. As such, the value to creditors of a forward commitment to sell stock (which commitment could expire if the Company becomes bankrupt) is greatly diminished.

### BRIEF DESCRIPTION OF THE DRAWINGS

Further aspects and/or embodiments may be appreciated upon review of the detailed description below when taken in conjunction with the accompanying drawings, of which:

FIG. 1 is a block diagram of a forward equity sale in accordance with some embodiments;

FIG. 2 is a flowchart of a process in accordance with some embodiments; and

FIG. 3 is a block diagram of processing system in accordance with some embodiments.

### DETAILED DESCRIPTION

According to some embodiments, systems, methods, apparatus and computer program products, are provided for use in association with a forward equity sale. In some embodiments, one or more of the systems, methods, apparatus and/or computer program products may permit non-investment grade and certain weak investment grade companies (and possibly others) to obtain one or more of the benefits cited above for mandatory convertible financing.

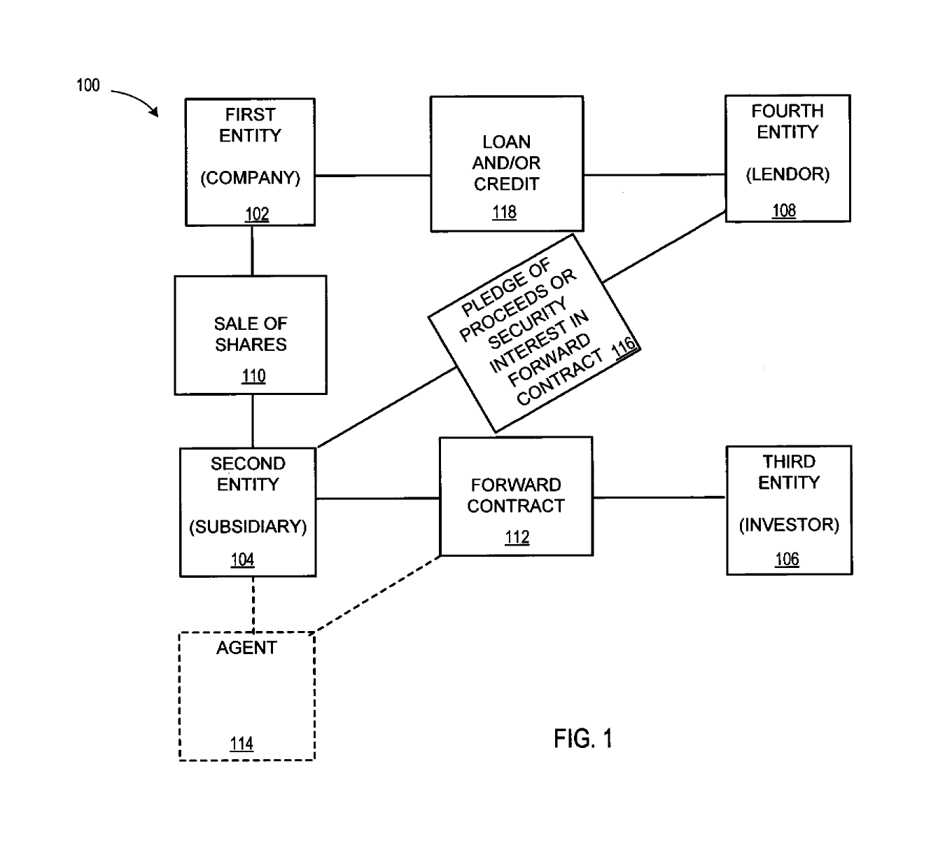

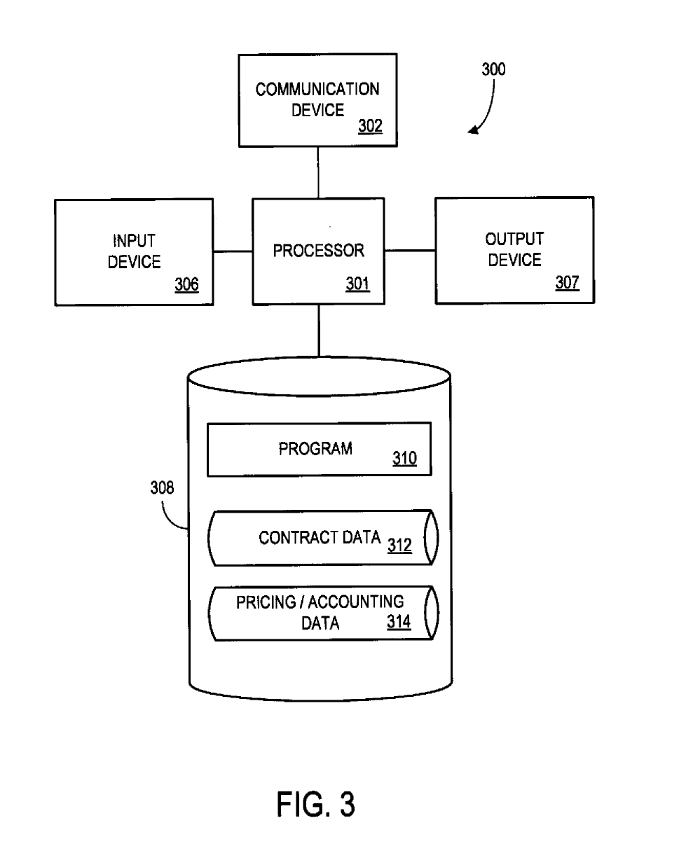

FIG. 1 is a block diagram of a forward equity sale 100 in accordance with some embodiments. It should be noted that a forward equity sale is not limited to the order presented in FIG. 1. In that regard, other embodiments may be performed in any order that is practicable. In addition, in some embodiments, one or more portions of the forward equity sale 100 may be employed without one or more other portions of the forward equity sale 100. In accordance with some embodiments, one or more portions of a forward equity sale 100 may be performed in a processing system. In that regard, in some embodiments, a processing system may be used to evaluate, price, define, issue, administer and/or manage one or more portions of the forward equity sale. As further described hereinafter, a processing system may be any type of processing system. In that regard, in some embodiments, a processing system may comprise hardware, software (including but not limited to microcode), firmware, or any combination thereof. In some embodiments, one or more portions of the forward equity sale may be performed by a processing system such as the processing system in FIG. 3.

Referring to FIG. 1, in some embodiments, a forward equity sale may involve a plurality of entities, e.g., a first entity 102, a second entity 104, a third entity 106 and a fourth entity 108. An entity may be any type of entity, including but not limited to, a company. In that regard, in some embodiments, a company may be public or private, incorporated or unincorporated and/or combinations thereof. If a company is a public company, such company may have issued publicly traded shares of common stock.

In accordance with some embodiments, the first entity 102 may be a company having a non-investment grade or weak investment grade credit rating. Such credit rating may indicate that the first entity 102 has a higher probability of becoming insolvent in the near term than an entity having an investment grade credit rating. Notwithstanding such non-investment grade or weak investment grade credit rating, the first entity 102 may desire to borrow funds or otherwise upsize its bank facility. In that regard, the first entity 102 may seek to raise capital and/or a line of credit. For the purposes of this disclosure, for simplicity, the borrowing or increase in credit or banking facility will be described with reference to the first entity 102, however, those skilled in the art will appreciate, upon reading this disclosure, that the second entity 104 may also (or alternatively) be seeking to borrow or increase a credit or banking facility.

In accordance with some embodiments, the second entity 104 may be a subsidiary of the first entity 102. In some such embodiments, the subsidiary may comprise a wholly owned subsidiary of the first entity 102. In particular, pursuant to some embodiments, the second entity 104 is formed to ensure that it is a bankruptcy remote subsidiary of the first entity 102 (e.g., where bankruptcy of the first entity 102 does not affect the solvency of the second entity 104).

In accordance with some embodiments, the third entity 106 may be an entity desiring to invest in debt and/or equity securities associated with the first entity 102. In some embodiments, the third entity 106 may comprise a financial institution. In some such embodiments, the financial institution may comprise an institutional investor, a brokerage, and/or an asset management company. In some embodiments, the financial institution may be an institution that is regulated by one or more authorities (e.g., an authority that regulates finance and/or securities). In some embodiments, the financial institution may be a financial institution of high credit standing.

In accordance with some embodiments, the fourth entity 108 may be an entity desiring to lend capital and/or provide credit to the first entity 102. In some embodiments, the fourth entity 108 may comprise a financial institution. In some such embodiments, the financial institution may comprise a lending institution, for example, a bank.

In accordance with some embodiments, the forward equity sale 100 may comprise a plurality of components. In some embodiments, each component of the forward equity sale may be performed as a separate transaction. In some other embodiments, two or more of the plurality of transactions may be performed in a single transaction. In some such embodiments, all of the plurality of components may be performed as a single transaction.

In a first component of the forward equity sale 100, the first entity 102 sells (or “issues”) shares of the first entity 102 to the second entity 104 for an amount of money. In some embodiments, the shares of stock may comprise shares of common stock of the first entity 102. If the shares have a par value, the amount of money paid for the shares may have a value that is at least equal to the par value. In some embodiments, the par value may be the issue price of the stock. In some other embodiments, the par value may be an extremely low value, e.g., one cent. If the second entity 104 comprises a subsidiary of the first entity 102, the first entity 102 may initially fund the subsidiary 104 with an amount of money sufficient to pay for the shares of stock.

In a second component of the forward equity sale 100, the second entity 104 may enter into a forward contract 112 with the third entity 106. The forward contract 112 (also referred to herein as a “forward sale contract”) may include terms that obligate the third entity 106 to purchase a number of shares of stock of the first entity 102 on a date (sometimes referred to hereinafter as a “settlement date”) for an amount of money (sometimes referred to hereinafter as the “settlement amount”), unless there has been an early settlement of the forward contract 112, as further described hereinafter. In some embodiments, the shares of stock comprise shares of common stock of the first entity 102. In some embodiments, the settlement amount comprises a notional amount of money. In some embodiments, the settlement amount comprises a notional amount in cash.

The entity with the obligation to sell the shares of stock, e.g., the second entity 104, under the forward contract 112 is sometimes referred to hereinafter as an issuer. The entity with the obligation to purchase the shares of stock, e.g., the third entity 106, under the forward contract 112 is sometimes referred to hereinafter as a holder.

In some embodiments, the forward contract 112 may comprise a mandatory convertible that includes the terms that obligate the third entity 106 to purchase the number of shares of stock of the first entity 102 on the settlement date for the settlement amount, unless there has been an early settlement of the forward contract, as further described hereinafter.

In some embodiments, the settlement amount, the settlement date and the number of shares (sometimes referred to herein as a “settlement rate”) are each fixed by the forward contract 112. In that regard, the forward contract 112 may include terms that specify the settlement amount, the settlement date and the number of shares in the form of a fixed price, fixed date and fixed number of shares, respectively.

In some other embodiments, the settlement amount, the settlement date and/or the number of shares are variable. To that effect, the forward contract 112 may include terms that specify the settlement amount and/or the number of shares in the form of a variable price and/or a variable number of shares, respectively. If the number of shares is variable, the forward contract 112 may be referred to as a variable share forward contract. In some embodiments, a fixed forward contract share price may be specified.

If the number of shares is variable, the forward contract 112 may include terms that specify a maximum number of shares to be received by the third entity 106 (sometimes referred to herein as a “maximum settlement rate”) and/or a minimum number of shares to be received by the third entity 106 (sometimes referred to herein as a “minimum settlement rate”). In some embodiments, the maximum settlement rate may be equal to the settlement amount divided by a reference price. In some such embodiments, the reference price may be the share price of the stock at issue. The minimum settlement rate may be equal to the settlement amount divided by a conversion price. In some such embodiments, the conversion price may be a maximum share price to be paid under the forward contract 112.

In addition, or in lieu thereof, if the number of shares to be received by the third entity 106 is variable, the forward contract 112 may include terms that specify a method for determining the actual number of shares to be received by the third entity 106. In some embodiments, if the forward contract 112 includes terms that specify a maximum settlement rate and/or a minimum settlement rate, the number of shares to be received by the third entity 106 may be greater than or equal to the minimum settlement rate and/or less than or equal to the maximum settlement rate.

In some embodiments, the number of shares to be received by the third entity 106 may be determined based, at least in part, on a closing price of the stock on one or more trading days on or before the settlement date. In that regard, in some embodiments, the number of shares may be determined based, at least in part, on a closing price of the stock on each trading day during a period ending on or before the settlement date (sometimes referred to herein as a “notice periods”).

In some embodiments, the number of shares to be received by the third entity 106 may be determined as a weighted sum of a maximum settlement rate, a minimum settlement rate and/or a closing price of the stock on one or more trading days on or before the settlement date. In some such embodiments, the number of shares may be determined as a weighted sum of a maximum settlement rate, a minimum settlement rate and the closing price of the stock on each trading day during a period ending on or before the settlement date.

If the forward contract 112 includes terms that specify a minimum number of shares to be received by the third entity 106, a maximum number of shares to be received by the third entity 106 and/or an actual number of shares to be received by the third party, such terms may be specified explicitly or implicitly. Thus, in some embodiments, the forward contract 112 may include terms that explicitly specify a minimum number of shares, e.g., one million shares. In some other embodiments, the forward contract 112 may include terms that implicitly specify a number of shares, for example, by specifying a total purchase price and a price per share. In the latter example, the minimum number of shares may be determined as the total purchase price divided by the price per share.

In some embodiments, the forward contract 112 may be structured to provide the second entity 104 with some or all of the downside of any drops in the stock price of the first entity 102 and/or some or all of the upside of any increase in the stock price of the first entity 102. In some embodiments, the forward contract 112 may be structured to provide the third entity 106 with some or all of the downside of any drops in stock price and/or some or all of the upside of any increase in stock price.

In some embodiments, the settlement date, the settlement amount and/or the number of shares to be received by the third entity 106 may be determined in accordance with one or more terms related to early settlement, further described hereinafter.

Other terms may be employed in addition to and/or in lieu of one or more of the terms above.

In some embodiments, second entity 104 enters the forward contract 112 directly with the third entity 106. In some embodiments, a third party intermediary (such as one or more agents 114) may participate in the forward contract 112. For example, agents 114 may be one or more underwriters, support companies, trustees, or the like (some of which will be discussed further below, some of which will be apparent to those skilled in the art).

In some embodiments, the third entity 106 may desire to hedge its position with respect to the forward contract 112. In that regard, in some embodiments, the third entity 106 may enter into a contract for a short sale of shares of stock of the first entity 102.

The short sale may be structured to cancel and/or reduce the risk represented by the obligation on the part of the third party to purchase stock of the first entity 102. In that regard, in some embodiments, the short sale may be a short sale of a number of shares equal to the number of shares to be received under the forward contract 112. In some other embodiments, the short sale may be a short sale of a number of shares less than the number of shares to be received under the forward contract 112.

In some embodiments, the short sale may be a registered short sale of common stock of the first entity 102. In some embodiments, a short sale may be registered by a shelf registration statement or a discrete registration statement.

In some embodiments, the second entity 104 may be required to pay the third entity 106 one or more contract payments in exchange for the obligation of the third entity 106 to pay the settlement amount at the settlement date. In some embodiments, a single payment may be required. In some other embodiments, contract payments may be required during the course of the contract on some regular basis, such as quarterly or annually. In some embodiments, the contract payment(s) may be calculated as a percentage of the settlement amount.

In some embodiments, the forward contract 112 may include one or more terms specifying one or more conditions that: (a) cause an adjustment to the contract payment, e.g., an interest adjustment to occur; and/or (b) cause contingent cash interest to be paid. As used herein, a “condition” may be any type of condition, and may include, for example, but is not limited to, an occurrence of an event. For example, in some embodiments, the forward contract 112 may include terms specifying that additional contingent interest will be paid starting some period of time after the issue date of the forward contract 112.

In some embodiments, the forward contract 112 may specify one or more conditions that require the third entity 106 to post collateral for the benefit of the second entity 104 and/or in order to secure the obligation of the third entity 106 to purchase the shares of stock of the first entity 102. In some such embodiments, the forward contract 112 may require that the third entity 106 post collateral in the event of a material decline in the credit rating of the third entity 106. In some embodiments, the collateral may comprise one or more assets of the third entity 106.

In some embodiments, the forward contract 112 may require that another entity, sometimes referred to herein as a guarantor (not shown), guarantee to fulfill the obligations of the third entity 106 in the event that the third entity 106 defaults on such obligations.

In some embodiments, the forward contract 112 may require that the third entity 106 post high credit quality, short-dated securities with a collateral agent (for the benefit of the second entity 104 and/or in order to secure the obligation of the third entity 106 to purchase the shares of stock of the first entity 102) in the event that the guarantor's senior unsecured credit rating, as determined by one or more predetermined inventor services, e.g., Moody's Investor Service, falls below a predetermined rating, e.g., Baa3.

In some embodiments, the forward contract 112 may require that the third entity 106 post collateral in all situations.

In some embodiments, the forward contract 112 may include one or more terms that may operate to accelerate settlement of the forward contract 112, sometimes referred to as an “early settlement”, under one or more conditions. As used herein, an “early settlement” obligates the third entity 106 to purchase a number of shares of stock of the first entity 102 on a date earlier than the settlement date (sometimes referred to hereinafter as an “early settlement date”). As stated above, as used herein, a “condition” may be any type of condition, and may include, for example, but is not limited to, an occurrence of an event. In that regard, in some embodiments, the forward contract 112 may include one or more terms that require early settlement (1) at the option of one or more of the entities, (2) a significant reduction in the credit rating of the one or more of the entities and/or (3) one or more of entities fail to satisfy one or more financial metrics.

In some embodiments, the forward contract 112 may be accelerable at the option of the second entity 104. In that regard, the forward contract 112 may include one or more terms that provide the second entity 104 with an option to accelerate settlement of the forward contract 112. For example, the forward contract 112 may be accelerable on three days notice at the option of the second entity 104.

In some embodiments, the forward contract 114 may include a mandatory acceleration provision to accelerate the forward contract in the event of credit deterioration of the second entity 104. Thus, the forward contract 112 may include one or more terms that accelerate settlement of the forward contract 112 in the event of deterioration in the credit rating of the second entity 104. In some such embodiments, the forward contract 112 may also be accelerable at the option of the second entity 104.

In some embodiments, the forward contract 112 may require that the second entity 104 early settle the forward contract 112 within a predetermined period (e.g., 30 days) if the first entity 102 and/or the second entity 104 fail to meet one or more predetermined financial metrics.

In some embodiments, the forward contract 112 may require that the second entity 104 settle the forward contract 112 within a predetermined period (e.g., 30 days) in the event of a bankruptcy of the first entity 102 and/or a bankruptcy of the second entity 104.

The settlement amount in an early settlement and the number of shares to be received by the third entity 106 in an early settlement may or may not be the same as the settlement amount in the absence of an early settlement and the number of shares to be received by the third party in the absence of an early settlement, respectively. Thus, in some embodiments, the settlement amount in an early settlement and the number of shares to be received by the third entity 106 in an early settlement may be the same as the settlement amount in the absence of an early settlement and the number of shares to be received by the third party in the absence of an early settlement, respectively. In some other embodiments, the settlement amount in an early settlement and/or the number of shares to be received by the third entity 106 in an early settlement may be different than the settlement amount in the absence of an early settlement and the number of shares to be received by the third party in the absence of an early settlement, respectively.

In some embodiments, the settlement amount in an early settlement and the number of shares to be received by the third entity 106 in an early settlement are each fixed by the forward contract 112. In that regard, the forward contract 112 may include terms that specify the settlement amount in an early settlement and the number of shares in an early settlement in the form of a fixed price and fixed number of shares, respectively.

In some other embodiments, the settlement amount in an early settlement and/or the number of shares to be received by the third entity 106 in an early settlement are variable. To that effect, the forward contract 112 may include terms that specify the settlement amount in an early settlement and/or the number of shares in an early settlement in the form of a variable price and/or a variable number of shares, respectively.

In addition, or in lieu thereof, if the number of shares to be received by the third entity 106 in an early settlement is variable, the forward contract 112 may include terms that specify a method for determining the actual number of shares to be received by the third entity 106 in an early settlement. In some embodiments, if the forward contract 112 includes terms that specify a maximum settlement rate and/or a minimum settlement rate, the number of shares to be received by the third entity 106 in early settlement may be greater than or equal to the minimum settlement rate and/or less than or equal to the maximum settlement rate.

In some embodiments, the number of shares to be received by the third entity 106 in an early settlement may be determined as a weighted sum of a maximum settlement rate, a minimum settlement rate and/or a closing price of the stock on one or more trading days on or before the settlement date. In some such embodiments, the number of shares may be determined as a weighted sum of a maximum settlement rate, a minimum settlement rate and the closing price of the stock on each trading day during a period ending on or before the settlement date.

In some embodiments, the forward contract 112 may be structured to provide the second entity 104 with some or all of the downside of any drops in the stock price of the first entity 102 and/or some or all of the upside of any increase in the stock price of the first entity 102. In some embodiments, the forward contract 112 may be structured to provide the third entity 106 with some or all of the downside of any drops in stock price and/or some or all of the upside of any increase in stock price.

In some embodiments, the forward contract 112 may specify that in an early settlement, the third entity 106 will receive a number of shares equal to the maximum settlement rate in exchange for (i) an amount of money equal to the settlement amount less a present value of remaining contract payments, if any, and (ii) an early settlement contract.

The early settlement contract may include one or more terms that specify one or more obligations on the part of the third entity 106. In some embodiments, the early settlement contract may include terms that obligate the third entity 106 to deliver an amount of cash and/or a number of shares of stock to the second entity 104 on the settlement date of the forward contract 112.

In some embodiments, the number of shares (sometimes referred to herein as an “early contract settlement rate”) is fixed by the early settlement contract. In that regard, the early settlement contract may include terms that specify the number of shares in the form of a fixed number of shares.

In some other embodiments, the number of shares is variable. To that effect, the early settlement contract may include terms that specify the number of shares in the form of a variable number of shares.

In addition, or in lieu thereof, if the number of shares under the early settlement contract is variable, the early settlement contract may include terms that specify a method for determining the actual number of shares to be received. In some embodiments, if the forward contract 112 includes terms that specify a maximum settlement rate and/or a minimum settlement rate, the number of shares under the early settlement contract may be greater than or equal to the minimum settlement rate and/or less than or equal to the maximum settlement rate.

In some embodiments, the number of shares under the early settlement contract may be determined based, at least in part, on a closing price of the stock on one or more trading days on or before the settlement date. In that regard, in some embodiments, the number of shares may be determined based, at least in part, on a closing price of the stock on each trading day during a period ending on or before the settlement date (sometimes referred to herein as a “notice period”).

In some embodiments, the number of shares under the early settlement contract may be determined as a weighted sum of a maximum settlement rate, a minimum settlement rate and/or a closing price of the stock on one or more trading days on or before the settlement date. In some such embodiments, the number of shares may be determined as a weighted sum of a maximum settlement rate, a minimum settlement rate and the closing price of the stock on each trading day during a period ending on or before the settlement date.

If the early settlement contract includes terms that specify a minimum number of shares to be received by the second entity 104, a maximum number of shares to be received by the second entity 104 and/or an actual number of shares to be received by the second entity 104, such terms may be specified explicitly or implicitly. Thus, in some embodiments, the early settlement contract may include terms that explicitly specify a minimum number of shares, e.g., one million shares. In some other embodiments, the early settlement contract may include terms that implicitly specify a number of shares, for example, by specifying a total purchase price and a price per share. In the latter example, the minimum number of shares may be determined as the total purchase price divided by the price per share.

In some embodiments, the early settlement contract may be structured to provide the second entity 104 with some or all of the downside of any drops in the stock price of the first entity 102 and/or some or all of the upside of any increase in the stock price of the first entity 102. In some embodiments, the early settlement contract may be structured to provide the third entity 106 with some or all of the downside of any drops in stock price and/or some or all of the upside of any increase in stock price.

In some embodiments, the early settlement contract may give one of the entities the option to determine whether the early settlement contract is settled in cash and/or in shares of stock. In that regard, in some such embodiments, the early settlement contract may specify that the second entity 104 has the option to determine whether the early settlement contract is settled in cash and/or in shares of stock.

In some embodiments, the early settlement contract may specify that the second entity 104 must elect to receive cash or shares of stock prior to the first day of the notice period, e.g., at least a predetermined number of trading days prior to the first day of the notice period.

In some embodiments, the forward contract 112 may include one or more standard anti-dilution adjustments with respect to the Settlement Rate, Maximum Settlement Rate, and Minimum Settlement Rate, which include adjustments for dividends on Company common stock in excess of the current level, stock splits, spin-offs, and other related events.

As stated above, the first entity 102 may desire to upsize its bank facility. In that regard, in some embodiments, the first entity 102 may seek to raise capital and/or a line of credit.

The fourth entity 108 may be an entity desiring to lend capital and/or provide credit to the first entity 102. However, as stated above, the first entity 102 may have a non-investment grade or week investment grade credit rating, which may indicate that the first entity 102 has a higher probability of becoming insolvent in the near term than an entity having an investment grade credit rating. Thus, the fourth entity 108 may insist on some form of collateral prior to agreeing to (1) loan money and/or (2) extend credit to the first entity 102.

In some embodiments, in a third component of the forward equity sale 100, the second entity 104 may pledge 116 some or all of the proceeds due under the forward contract 112. In some embodiments, the second entity 104 may grant the fourth entity 108 a security interest in the right of the second entity 104 to be paid under the forward contract 112. Such security interest may help to ensure that the fourth entity 108 could enforce its rights against the right of the second entity 104 to be paid under the forward contract 112.

With a pledge 116 of the proceeds due under the forward contract 112 and/or a security interest in place, in a fourth component of the forward equity sale 100, the fourth entity 108 may enter into a contract 118 to loan an amount of money and/or extend an amount of credit to the first entity 102. The first entity 102 may, in return, promise to repay the amount of money loaned and/or the amount of credit extended by the fourth entity 108.

In some embodiments, the amount of money loaned and/or the amount of credit extended by the fourth entity 108 under the contract 118 may be equal to the settlement amount of the forward contract 112.

In some embodiments, the amount of money loaned and/or the amount of credit extended by the fourth entity 108 to the first entity 102 under the contract 118 may be in addition to an amount of money previously loaned by the fourth entity 108 to the first entity 102 and/or an amount of credit previously extended by the fourth entity 108 to the first entity 102.

In some embodiments, the first entity 102 may upsize its bank facility at the same time as the second entity 104 enters into the forward contract 112. In some other embodiments, the first entity 102 may upsize its bank facility at some time after the second entity 104 enters into the forward contract 112. In some embodiments, the financing may be effected in connection with a cash funding need (for example, to finance an acquisition or a capital expenditure).

In some embodiments, the existence of the forward contract 112 will likely enhance the terms and/or amount of bank financing that a non-investment grade company would be able to obtain.

In some embodiments, the first entity 102 and/or the second entity 104 may be entitled to deduct some or all of the interest accruing on a loan from the fourth entity 108.

In some embodiments, from the perspective of first entity 102, forward contract 112 is structured to be a non-taxable transaction in issuer stock.

In some embodiments, the promise on the part of the first entity 102 to repay may be in the form of a note, e.g., a promissory note. The note may include terms that specify a principal amount, an interest rate and/or a maturity date.

Applicants believe that such a structure is legally enforceable in the event of a bankruptcy of the parent, subsidiary or both.

Applicants believe that some embodiments of the transactions, systems, methods, apparatus and/or products disclosed herein provide one or more benefits. For example, pursuant to some embodiments, forward equity sales can become a more relevant form of equity financing for weak investment grade and non-investment grade companies. While providing low cost, non-dilutive financing, this structure should be viewed more favorably by creditors of the Company and the credit rating agencies.

Some embodiments of the transactions, systems, methods, apparatus and/or products disclosed herein may permit non-investment grade and certain weak investment grade companies (and possibly others) to obtain the one, some or all of the benefits cited above for mandatory convertible financing by 1) restructuring the forward contract such that it is enforceable in bankruptcy and/or 2) separating the issuance of the Company's debt and the forward contract such that the Company's ability to obtain deductions on the interest expense in its debt would not be impaired.

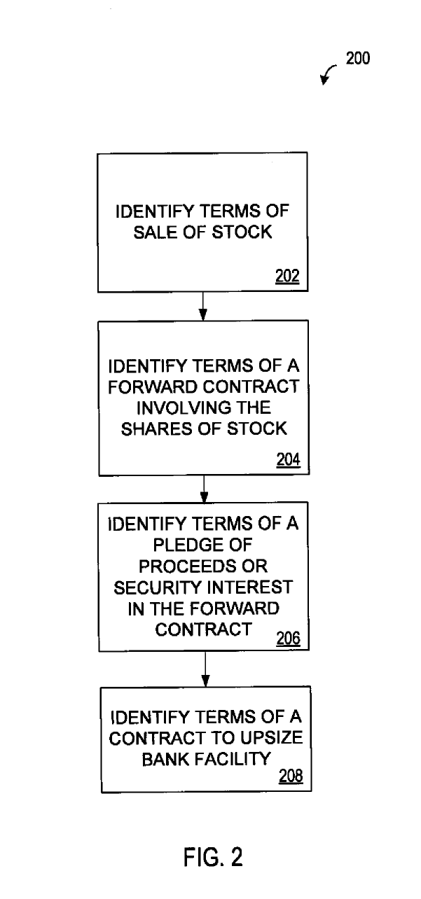

FIG. 2 is a flow chart 200 of a process according to some embodiments. In some embodiments, one or more portions of the process may be used to carry out one or more portions of one or more embodiments of a forward equity sale as described above. The process is not limited to the order shown in the flow chart. Rather, embodiments of the process may be performed in any order that is practicable. For that matter, unless stated otherwise, any process disclosed herein may be performed in any order that is practicable. Unless stated otherwise, the process may be performed by in any manner. In some embodiments, one or more portions of one or more process may be performed by a processing system. As further described hereinafter, in some embodiments, a processing system may comprise hardware, software (including microcode), firmware, or any combination thereof In some embodiments, one or more portions of one or more processes disclosed herein may be performed by a processing system such as the processing system in FIG. 3.

The process shown in FIG. 2 is described hereinafter in association with an example. In the example, the first entity 102 is a large public company (referred to in this example as the “Company”) that wishes to utilize one or more embodiments of one or more aspects of the present invention. The second entity 104 is a subsidiary (referred to in this example as the “Subsidiary”) of the Company. The third entity 106 is a qualified institutional investor (referred to in this example as the “Investor”) desiring to invest in stock of the Company. The fourth entity 108 is a lending institution (referred to in this example as the “Lender”) desiring to lend capital and/or provide credit to the Company 102.

In the example, the Company has a non-investment grade or week investment grade credit rating, which as stated above, indicates that the Company has a higher probability of becoming insolvent in the near term than an entity having an investment grade credit rating. Notwithstanding such credit rating, the Company desires to raise capital.

At 202, terms of a contract to sell a number of shares of Company common stock to the Subsidiary are identified. In the example, the terms of the contract specify that the shares of Company common stock are sold to the Subsidiary for an amount of cash equal to the par value of the stock. In some embodiments, the par value may be the issue price of the Company common stock. In some other embodiments, the par value may be an extremely low value, e.g., one cent. The Company may fund the Subsidiary with an amount of cash sufficient to pay for the shares of Company common stock. In the example, the number of shares Company common stock is one million (1,000,000) and the issue price of the Company common stock is $100.00 per share.

At 204, the Company and the Investor may interact to identify terms of a forward contract involving the Subsidiary, the Investor and the common stock of the Company. In the example, the forward contract obligates the Investor to purchase a number of shares of Company common stock on a settlement date three (3) years from the initiation date of the forward contract for a settlement amount equal to one hundred million dollars ($100,000,000) in cash, unless there has been an early settlement of the forward contract, as described hereinafter. Using the terminology introduced above, the Subsidiary acts as an issuer of the forward contract and the Investor acts as a holder of the forward contract.

In the example, the number of shares to be purchased by the Investor is variable. In that regard, the forward contract specifies a reference price, a conversion price, a maximum settlement rate and a minimum settlement rate. The reference price represents a minimum share price to be paid under the forward contract and is specified as one hundred dollars ($100.00), i.e., the price of the Company common stock at issue. The conversion price represents a maximum share price to be paid under the forward contract and is specified as one hundred twenty five dollars ($125.00). The maximum settlement rate is specified as one million shares (1,000,000), i.e., the settlement amount divided by the reference price. The minimum settlement rate is specified as eight hundred thousand shares (800,000), i.e., the settlement amount divided by the conversion price.

In the example, the settlement rate is based in part on the closing price of the Company common stock on each of twenty (20) consecutive trading days ending on the fifth (5) trading day prior to the settlement date (the “notice period”).

More particularly, the forward contract specifies that the settlement rate is determined as a sum of twenty (20) partial settlement rates, i.e., one for each trading day in the notice period. That is, in the example, the settlement rate is determined as a sum of (1) a partial settlement rate for the first trading day of the notice period, (2) a partial settlement rate for the second trading day of the notice period, (3) a partial settlement rate for the third trading day of the notice period, (4) a partial settlement rate for the fourth trading day of the notice period, (5) a partial settlement rate for the fifth trading day of the notice period, (6) a partial settlement rate for the sixth trading day of the notice period, (7) a partial settlement rate for the seventh trading day of the notice period, (8) a partial settlement rate for the eighth trading day of the notice period, (9) a partial settlement rate for the ninth trading day of the notice period, (10) a partial settlement rate for the tenth trading day of the notice period, (11) a partial settlement rate for the eleventh trading day of the notice period, (12) a partial settlement rate for the twelfth trading day of the notice period, (13) a partial settlement rate for the thirteenth trading day of the notice period, (14) a partial settlement rate for the fourteenth trading day of the notice period, (15) a partial settlement rate for the fifteenth trading day of the notice period, (16) a partial settlement rate for the sixteenth trading day of the notice period, (17) a partial settlement rate for the seventeenth trading day of the notice period, (18) a partial settlement rate for the eighteenth trading day of the notice period, (19) a partial settlement rate for the nineteenth trading day of the notice period and a (20) a partial settlement rate for the twentieth trading day of the notice period.

In the example, the partial settlement rate for a trading day in the notice period is determined in accordance with the following formula:
(1) If the closing price of the Company stock on the trading day is less than the reference price, then the partial settlement rate for the trading day is equal to the product of (a) one divided by the number of trading days in the notice period and (b) the maximum settlement rate, i.e.,
   partial settlement rate=(1/number of trading days)×(maximum settlement rate);
(2) If the closing price of the Company stock on the trading day is greater than or equal to the reference price and less than or equal to the conversion price, then the partial settlement rate for the trading day is equal to the product of (a) one divided by the number of trading days in the notice period and (b) the settlement amount divided by the closing price of the Company stock on the trading day, i.e.,
   partial settlement rate=(1/number of trading days)×(settlement amount/closing price);
(3) If the closing price of the Company stock on the trading day is greater than the conversion price, then the partial settlement rate for the trading day is equal to the product of (a) one divided by the number of trading days in the notice period and (b) the minimum settlement rate, i.e.,
   partial settlement rate=(1/number of trading days)×(minimum settlement rate);

where
partial settlement rate is the partial settlement rate for the trading day, number of trading days is the number of trading days in the notice period and closing price is the closing price of Company stock on the trading day.

Thus, in the example, the settlement rate is a weighted sum of the maximum settlement rate, the minimum settlement rate and a closing price of the Company common stock on each of twenty (20) consecutive trading days ending on the fifth (5) trading day prior to the settlement date (the “notice period”).

In some embodiments, each partial settlement rate is determined at the end of the respective trading day. In some other embodiments, all partial settlement rates are determined at the end of the notice period.

In the example, the forward contract specifies that the Subsidiary may elect to accelerate settlement of the forward contract at any point prior to the settlement date. In that regard, in this example, the forward contract further specifies that upon such early settlement, the Subsidiary will deliver, to the Investor, a number of shares of Company common stock equal to the maximum settlement rate in exchange for (i) cash equal to the settlement amount, i.e., one hundred million dollars ($100,000,000) less a present value of remaining contract payments, if any, and (ii) an early settlement contract, further described hereinafter. The forward contract further specifies that the obligations of the Subsidiary under the forward contract and the obligations of the Investor under the forward contract are both satisfied in fill upon delivery of the shares to the Investor and delivery of the settlement amount and the early settlement contract to the Subsidiary.

In the example, the forward contract specifies that the early settlement contract will require that the Investor deliver a number of shares to the Subsidiary on the settlement date. The number of shares to be delivered to the Subsidiary is referred to hereinafter as an early settlement rate.

In the example, the early settlement rate is variable. In that regard, in the example, the early settlement rate is based in part on a closing price of the Company common stock on each of twenty (20) consecutive trading days ending on the fifth (5) trading day prior to the settlement date (the “notice period”).

More particularly, the forward contract specifies that the early settlement rate will be determined as a sum of twenty (20) partial early settlement rates, i.e., one for each trading day in the notice period. That is, in this example, the early settlement rate is determined as a sum of (1) a partial early settlement rate for the first trading day of the notice period, (2) a partial early settlement rate for the second trading day of the notice period, (3) a partial early settlement rate for the third trading day of the notice period, (4) a partial early settlement rate for the fourth trading day of the notice period, (5) a partial early settlement rate for the fifth trading day of the notice period, (6) a partial early settlement rate for the sixth trading day of the notice period, (7) a partial early settlement rate for the seventh trading day of the notice period, (8) a partial early settlement rate for the eighth trading day of the notice period, (9) a partial early settlement rate for the ninth trading day of the notice period, (10) a partial early settlement rate for the tenth trading day of the notice period, (11) a partial early settlement rate for the eleventh trading day of the notice period, (12) a partial early settlement rate for the twelfth trading day of the notice period, (13) a partial early settlement rate for the thirteenth trading day of the notice period, (14) a partial early settlement rate for the fourteenth trading day of the notice period, (15) a partial early settlement rate for the fifteenth trading day of the notice period, (16) a partial early settlement rate for the sixteenth trading day of the notice period, (17) a partial early settlement rate for the seventeenth trading day of the notice period, (18) a partial early settlement rate for the eighteenth trading day of the notice period, (19) a partial early settlement rate for the nineteenth trading day of the notice period and a (20) a partial early settlement rate for the twentieth trading day of the notice period.

In the example, the partial early settlement rate for a trading day in the notice period is determined in accordance with the following formula:
(1) If the closing price of the Company stock on the trading day is less than the reference price, then the partial early settlement rate for the trading day is zero, i.e.,
   partial early settlement rate=0;
(2) If the closing price of the Company stock on the trading day is greater than or equal to the reference price and less than or equal to the conversion price, then the partial early settlement rate for the trading day is equal to the product of (a) one divided by the number of trading days in the notice period and (b) (i) the settlement amount divided by the closing price of the Company stock on the trading day less (ii) the minimum settlement rate, i.e.,
   partial early settlement rate=(1/number of trading days)×((settlement amount/closing price)−minimum settlement rate));
(3) If the closing price of the Company stock on the trading day is greater than the conversion price, then the partial early settlement rate for the trading day is equal to the product of (a) one divided by the number of trading days in the notice period and (b) the maximum settlement rate less the minimum settlement rate, i.e.,
   partial early settlement rate=(1/number of trading days)×(maximum settlement rate−minimum settlement rate);

where
partial early settlement rate is the partial early settlement rate for the trading day, number of trading days is the number of trading days in the notice period and closing price is the closing price of Company stock on the trading day.

Thus, in this example, the early settlement rate is a weighted sum of the maximum settlement rate, the minimum settlement rate and a closing price of the Company common stock on each of twenty (20) consecutive trading days ending on the fifth (5) trading day prior to the settlement date (the “notice period”).

In some embodiments, each partial early settlement rate is determined at the end of the respective trading day. In some other embodiments, all partial early settlement rates are determined at the end of the notice period.

In the example, the forward contract specifies that the early settlement contract will further require that the early settlement contract be settled in cash or shares of Company common stock solely at the option of the Subsidiary. The forward contract further specifies that the early settlement contract will require that the Subsidiary elect to receive cash or shares of Company common stock at least a predetermined number of trading days prior to the first day of the notice period.

The forward contract may further specify that the Subsidiary is to make contract payments to the Investor. If so, the forward contract may specify a contract payment schedule (e.g., quarterly) and a contract payment amount and/or contract payment rate (e.g., seven percent (7.00%).

In the example, the forward contract further specifies that in the event of bankruptcy of the Company or Subsidiary, the forward contract must be settled by the Subsidiary within a predetermined number (e.g., 30) of days. In addition, the forward contract requires that the Subsidiary early settle the forward contract if the Company fails predetermined financial metrics.

In the example, the forward contract further requires that another entity, sometimes referred to herein as a guarantor, guarantee to fulfill the obligations of the Investor in the event that the Investor defaults on one or more of the obligations of the Investor under the forward contract. The forward contract may also require that the Investor post high credit quality, short-dated securities with a collateral agent (for the benefit of the Subsidiary and/or in order to secure the obligation of the Investor to purchase the shares of Company common stock) in the event that the guarantor's senior unsecured credit rating, as determined by one or more predetermined inventor services, e.g., Moody's Investor Service, falls below a predetermined rating, e.g., Baa3.

The forward contract may include terms identifying one or more forms of collateral deemed acceptable. In some embodiments, the forward contract may specify that U.S. Treasury securities equal to the settlement amount (e.g., $100,000,000) on the settlement date are acceptable as collateral.

The forward contract may further include standard anti-dilution adjustments with respect to the Settlement Rate, Maximum Settlement Rate, and Minimum Settlement Rate, which include adjustments for dividends on Company common stock in excess of the current level, stock splits, spin-offs, and other related events.

The parties may specify further terms as needed to create an enforceable forward contract.

The Investor may desire to hedge its position with respect to the forward contract. In that regard, in some embodiments, the Investor may enter into a contract for a short sale of shares of Company common stock. The short sale may be structured to cancel and/or reduce the risk represented by the obligation on the part of the Investor to purchase the shares of Company common stock. In that regard, in some embodiments, the short sale may be a short sale of a number of shares equal to the number of shares to be received under the forward contract. In some other embodiments, the short sale may be a short sale of a number of shares less than the number of shares to be received under the forward contract. In some embodiments, the short sale may be a registered short sale of common stock of the Company. In some embodiments, a short sale may be registered by a shelf registration statement or a discrete registration statement.

In some embodiments, the Subsidiary may enter into more than one forward contract. In some embodiments, for example, the Subsidiary may enter into ten forward contracts with ten different holders, respectively.

As stated above, the Company may desire to upsize its bank facility. In that regard, the Company may seek to raise capital and/or a line of credit.

In the example, the Lender desires to lend capital and/or provide credit to the Company. However, the non-investment grade or week investment grade credit rating of the Company indicates that the Company has a higher probability of becoming insolvent in the near term than an entity having an investment grade credit rating. Thus, the Lender may insist on some form of collateral prior to agreeing to (1) loan money and/or (2) extend credit to the Company.

At 206, the Company and the Lender may interact to identify terms of a pledge on the part of the Subsidiary of some or all of the proceeds due under the forward contract. In some embodiments, the Subsidiary may grant the Lender a security interest in the right of the Subsidiary to be paid under the forward contract. Such security interest may help to ensure that the Lender could enforce its rights against the right of the Subsidiary to be paid under the forward contract.

At 208, the Company and the Lender may interact to identify terms of a contract to loan an amount of money and/or extend an amount of credit to the Company. In return, the Company may promise to repay the amount of money loaned and/or the amount of credit extended by the Lender.

In this example, the amount of money loaned and/or the amount of credit extended by the Lender is equal to the settlement amount, i.e., $100,000,000, of the forward contract. Such amount of money loaned and/or such amount of credit extended by the Lender to the Company may be in addition to an amount of money previously loaned and/or an amount of credit previously extended by the Lender to the Company.

In some embodiments, the Company may upsize its bank facility at the same time as the Subsidiary enters into the forward contract. In some other embodiments, the Company may upsize its bank facility at some time after the Subsidiary enters into the forward contract. In some embodiments, the financing may be effected in connection with a cash funding need (for example, to finance an acquisition or a capital expenditure).

In some embodiments, the existence of the forward contract will likely enhance the terms and/or amount of bank financing that a non-investment grade company would be able to obtain.

In some embodiments, Company and/or the Subsidiary is entitled to deduct some or all of the interest accruing on a loan from the Lender.

In some embodiments, the promise on the part of the Company to repay may be in the form of a note, e.g., a promissory note. The note may include terms that specify a principal amount, an interest rate and/or a maturity date. In some embodiments, the note may comprise a convertible note.

In some embodiments, the Company may enjoy a lower cost of capital than would be available to the Company through one or more other forms of raising capital.

As stated above, Applicants believe that some embodiments of the transactions, systems, methods, apparatus and/or products disclosed herein provide one or more benefits. For example, pursuant to some embodiments, forward equity sales can become a more relevant form of equity financing for weak investment grade and non-investment grade companies. While providing low cost, non-dilutive financing, this structure should be viewed more favorably by creditors of the Company and the credit rating agencies.

Some embodiments of the transactions, systems, methods, apparatus and/or products disclosed herein may permit non-investment grade and certain weak investment grade companies (and possibly others) to obtain the one, some or all of the benefits cited above for mandatory convertible financing by 1) restructuring the forward contract such that it is enforceable in bankruptcy and/or 2) separating the issuance of the Company's debt and the forward contract such that the Company's ability to obtain deductions on the interest expense in its debt would not be impaired.

FIG. 3 is a block diagram of a processing system in accordance with some embodiments. In some embodiments, the processing system may be used to carry out one or more portions of the forward equity sale of FIG. 1 and/or one or more portions of the process of FIG. 2. Similarly, any of the participants (such as the issuer, the holder, or the agent) may utilize a processing system to evaluate, price, define, issue, administer, and/or manage one or more portions of the forward equity sale of FIG. 1 and/or one or more portions of the process of FIG. 2.

Referring to FIG. 3, in some embodiments, a processing system 300 includes a processor 301 operatively coupled to a communication device 302, an input device 306, an output device 307 and a storage device 308. The communication device 302 may be used to facilitate communication with, for example, other devices and other participants (such as, for example, devices operated by holders, issuers, agents, market data providers, etc.). The input device 306 may comprise, for example, one or more devices used to input data and information, such as, for example: a keyboard, a keypad, a mouse or other pointing device, a microphone, knob or a switch, an infra-red (IR) port, etc. The output device 307 may comprise, for example, one or more devices used to output data and information, such as, for example: an IR port, a docking station, a display, a speaker, and/or a printer, etc. The storage device 308 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 308 may store one or more programs 310, which may include one or more instructions to be executed by the processor 301 to perform one or more portions of one or more embodiments disclosed herein.

In some embodiments, one or more of the programs 310 may include one or more rules that may be used in evaluating, pricing, determining terms, issuing, administering and/or managing one or more portions of the forward equity sale of FIG. 1 and/or one or more portions of the process of FIG. 2.

In some embodiments, one or more of the programs 310 may include rules that may be used in identifying the occurrence of events associated with issuing and/or administering one or more portions of the forward equity sale of FIG. 1 and/or one or more portions of the process of FIG. 2.

In some embodiments, storage device 308 may store one or more databases, including, for example, contract data 312 and/or pricing and accounting data 314. In some embodiments, one or more of the databases may be used in issuing and/or administering one or more portions of the forward equity sale of FIG. 1 and/or one or more portions of the process of FIG. 2.

For example, unit data 312 may include information associated with the terms and conditions of existing forward equity sales and may be used in monitoring and administering the forward equity sales. Other programs and/or databases may also be employed.

In some embodiments, program 310 may be configured as a neural-network or other type of program using techniques known to those skilled in the art to achieve the functionality described herein.

In some embodiments, system 300 may be operated by one or more administrators acting to assist in, or direct the evaluation, pricing, defining, issuing, administering, and/or managing one or more portions of the forward equity sale of FIG. 1 and/or one or more portions of the process of FIG. 2.

In some embodiments, processing system 300 may be in communication with, or have access to, a number of types of market data and information (e.g., via communication device 302). In some embodiments, a user of processing system 300 may enter a number of terms associated with forward equity sales and may receive pricing and other data as outputs, allowing the user to price, define and/or evaluate the desirability of a forward equity sale having particular terms. For example, the user may input information such as an identification of the issuer stock associated with the forward equity sale and information associated with the structure of one or more portions of the forward equity sale (including, for example, settlement and maturity information).

In some embodiments, the processing system 300 may then operate to obtain information and/or data from different data sources. For example, system 300 may receive the following types of market data or information: a dividend yield on the issuer common stock; a historical volatility of the issuer common stock; implied volatilities for listed call and put option series of the issuer common stock; current interest rates; the issuer's credit rating; and rates achievable on nonconvertible instruments of the issuer. Further, information may also be obtained associated with similar data for previous issuers of optional and mandatory convertible instruments, and the yield and conversion premium and other terms achieved by these previous issuers of optional and mandatory convertibles.

In some embodiments, each of the items of information obtained by system 300 may then be used to evaluate, price, define, evaluate, issue, administer and/or manage terms of forward equity sale.

As used herein, a processing system may be any type of processing system. A processor may be any type of processor. For example, a processing system may be programmable or non programmable, general purpose or special purpose, dedicated or non dedicated, distributed or non distributed, shared or not shared, and/or any combination thereof. If the processing system has two or more distributed portions, the two or more portions may communicate with one another through a communication link. A processor system may include, for example, but is not limited to, hardware, software, firmware, hardwired circuits and/or any combination thereof

As used herein, a communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

While various embodiments have been described, such description should not be interpreted in a limiting sense. It is to be understood that modifications of such embodiments, as well as additional embodiments, may be utilized without departing from the spirit and scope of the invention, as recited in the claims appended hereto.

For example, in some embodiments, the forward contract 112 may include one or more terms that are the same as and/or similar to one or more terms of one or more embodiments of the forward contract 120 disclosed in U.S. Patent Application Publication 20040133494 of U.S. patent application Ser. No. 10/707,491, entitled “METHOD AND APPARATUS FOR ISSUING A UNIT” filed on Dec. 17, 2003 in the name of Jones et al., the entirety of which is incorporated by reference herein. It should be understood, however, that the systems and/or methods disclosed in the present application are not limited to the systems and/or methods disclosed in the applications incorporated by reference herein.

For example, in some embodiments, the forward contract 112 may specify that the holder 104 is to receive an amount of stock of issuer 102 that initially (e.g., as of the “issue date” of the unit) has a value equal to the settlement amount. In such embodiments, the holder may experience the full downside of any drop in stock price and the full upside of any appreciation in stock price. In some embodiments, the forward contract 112 may be structured to provide holder 104 with less than all of the downside of any drops in stock price subsequent to the issue date and/or less than all of the upside of any appreciation in stock price subsequent to the issue data. In some embodiments, the forward contract 112 may be structured so as to provide the full downside of any drop in stock price and no upside of any appreciation in stock price after the issue date. In such embodiments, the number of shares may be reduced if the value of the issuer's stock increases such that the holder never receives stock worth more than the settlement amount.

It is therefore contemplated that the appended claims will cover any such modifications and/or embodiments.

What is claimed is:

1. A method comprising:
issuing a number of shares of a first entity to a second entity, where the second entity is a bankruptcy remote subsidiary of the first entity;
creating a forward sale contract in which the second entity sells the number of shares of the first entity to a third entity;
creating an agreement between the fourth entity and at least one of the first entity and the second entity in which that first or second entity borrows funds from the fourth entity; and
creating at least one of a pledge and a security interest such that the fourth entity's right to repayment is secured by the right of the second entity to be paid under the forward sale contract.

2. The method of claim 1 wherein the agreement to borrow funds is an agreement causing funds to be provided to the first entity.

3. The method of claim 1, wherein the agreement to borrow funds is an agreement to establish a credit facility for the first entity.

4. The method of claim 1, wherein the issuing a number of shares comprises a sale of shares for cash in an amount equal to the par value of the shares.

5. The method of claim 1, wherein the forward sale contract is a variable-share forward contract converting into a variable number of shares within a fixed range tied to the stock price of the first entity.

6. The method of claim 1, wherein the forward sale contract is a fixed-share forward contract converting into a fixed number of shares.

7. The method of claim 1, further comprising:
entering into a hedging transaction, by the third entity including a registered short sale of shares of stock of the first entity.

8. The method of claim 1, wherein the forward sale contract obligates the second entity to pay at least one payment to the third entity prior to the settlement date.

9. The method of claim 1 wherein at least one of the first entity and the second entity have a non-investment grade or weak investment grade credit rating.

10. The method of claim 1, wherein the forward sale contract requires an early settlement of the forward sale contract in event of bankruptcy of the first entity.

11. The method of claim 1, wherein the forward sale contract specifies financial metrics and requires an early settlement of the forward sale contract if the first entity fails to meet the financial metrics.

12. The method of claim 1, wherein the forward sale contract further specifies that the second entity have an option to request an early settlement.

13. The method of claim 5, wherein the forward sale contract specifies that the number of shares of stock depends on a closing price of the shares of stock on a trading day.

14. A method for entering into a debt transaction between a lender and a borrower, wherein the borrower has established a bankruptcy remote subsidiary and has issued shares of the borrower to the subsidiary, the method comprising:
creating an agreement between the lender and the borrower in which the borrower borrows funds from the lender; and
creating at least one of a pledge and a security interest in which the lender's right to repayment is secured by the right of the bankruptcy remote subsidiary to be paid under a forward sale contract between the bankruptcy remote subsidiary and an investor, where the forward sale contract obligates the subsidiary to sell the issued shares to the investor.

15. The method of claim 14, wherein the forward sale contract is a variable-share forward contract converting into a variable number of shares within a fixed range tied to the stock price of the borrower, the method further comprising:
receiving market data identifying a stock price of the borrower.

16. A method for securing a lender's interest in a debt transaction between the lender and a borrower in which the lender has provided funds to the borrower in exchange for a promise to repay the lender, wherein the borrower has established a subsidiary and has issued shares of the borrower to the subsidiary, the method comprising:
creating a forward sale contract in which the subsidiary sells the issued shares to an investor; and
creating at least one of a pledge and a security interest in which the lender's right to repayment is secured by the right of the subsidiary to be paid under the forward sale contract.

17. A method comprising:
receiving data identifying the transfer of shares of a first entity to a second entity, where the second entity is a bankruptcy remote subsidiary of the first entity;
receiving data identifying terms of a proposed forward contract between the second entity and a third entity, the forward contract involving shares of stock of the first entity;
receiving data identifying terms of a loan from a fourth entity to the first entity;
receiving data identifying terms of a security interest in a right of the second entity to be paid under the forward contract, and securing an obligation of the first entity to repay the fourth entity for the loan; and
administering at least one portion of at least one of the forward contract, the loan, and the security interest, based at least in part, on at least one of: the data identifying terms of the proposed forward contract, the data identifying terms of the loan, the data identifying terms of the security interest and the market data.
